(19) United States
(12) Patent Application Publication
(10) Pub. No.: US 2022/0106766 A1
(43) Pub. Date: Apr. 7, 2022

(54) CONTROL UNIT FOR A HYDRAULIC SYSTEM

(71) Applicant: Volvo Construction Equipment AB, Eskilstuna (SE)

(72) Inventors: Johan Lillemets, Eskilstuna (SE); Bo Vigholm, Stora Sundby (SE)

(21) Appl. No.: 17/425,105

(22) PCT Filed: Jan. 23, 2019
(86) PCT No.: PCT/EP2019/051613

§ 371 Date: Jul. 22, 2021

(51) Int. Cl. E02F 9/20; E02F 9/22; F15B 11/04; F15B 21/14

(52) U.S. Cl. CPC E02F 9/2012; F15B 2211/761; E02F 9/2228; F15B 11/04; F15B 21/14; F15B 2211/3058; F15B 2211/41581; F15B 2211/426; F15B 2211/6313; F15B 2211/6346; F15B 2211/6654; F15B 2211/7053; F15B 2211/7058; F15B 2211/75; E02F 9/2203

(57) ABSTRACT

A control unit for a hydraulic system includes a hydraulic actuator including an actuator chamber the hydraulic actuator including a first actuator portion and a second actuator portion wherein the first actuator portion can move relative to the second actuator portion, the actuator chamber being in fluid communication with a flow rale control arrangement adapted to control a rate of flow from the actuator chamber. The control unit is adapted to receive a load signal indicative of the magnitude of the load applied to the hydraulic actuator, receive a requested speed signal indicative of a desired relative movement speed between the first actuator portion and the second actuator portion in a direction that reduces the chamber volume, and based on the load signal and the requested speed signal, issue a control signal to the flow rate control arrangement indicative of a desired flow rate from the actuator chamber.

### FIELD OF INVENTION

The invention relates to a control unit for a hydraulic system according to the preamble of claim 1. Furthermore, the present invention relates to a hydraulic system as well as to a working machine. Moreover, the present invention relates to a method for controlling the movement of a hydraulic system actuator of a hydraulic system or in other types of hydraulic systems.

The invention is for instance applicable on working machines within the fields of industrial construction machines or construction equipment, in particular wheel loaders. Although the invention will be described with respect to a wheel loader, the invention is not restricted to this particular machine, but may also be used in other working machines such as articulated haulers, excavators and backhoe loaders.

### BACKGROUND OF THE INVENTION

A hydraulic system generally comprises an actuator. Moreover, the hydraulic system generally also comprises means for controlling the movement of the actuator in response to for instance the actuation of a manually operated lever. An example of such a hydraulic system is presented in U.S. Pat. No. 6,170,262 B1. In the system disclosed in U.S. Pat. No. 6,170,262 B1, an actuator load is determined by measuring the pressure of a fluid fed to an actuator chamber in order to extract or retract the actuator and the magnitude of a fluid flow to that actuator chamber is thereafter determined on the basis of the thus determined actuator load and a detected position of a manually operated actuator lever.

Although the U.S. Pat. No. 6,170,262 B1 system may be suitable for certain operations, there are actuator operations for which the system disclosed in U.S. Pat. No. 6,170,262 B1 is not particularly useful. An example of such an actuator operation is an operation in which the movement speed of the actuator exceeds the actuator movement speed occasioned by fluid fed to the actuator chamber. For instance, in an actuator operation during which the movement of a first actuator portion relative to a second actuator portion is caused by an external load applied to the first actuator portion, for instance a gravity load, the U.S. Pat. No. 6,170,262 B1 system may not be able to control the movement of the first actuator portion relative to the second actuator portion in an appropriate manner.

### SUMMARY OF INVENTION

In view of the above, an object of the present invention is to provide a control unit for a hydraulic system comprising an actuator which control unit can control the movement of the actuator in a manner that is better than a manner obtained by the system proposed by U.S. Pat. No. 6,170,262 B1 for at least one operating condition.

This object is achieved by a control unit according to claim 1.

As such, the present invention relates to a control unit for a hydraulic system. The hydraulic system comprises a hydraulic actuator which in turn comprises an actuator chamber. The hydraulic actuator comprises a first actuator portion and a second actuator portion wherein the first actuator portion can move relative to the second actuator portion. The actuator chamber is in fluid communication with a flow rate control arrangement adapted to control a rate of flow from the actuator chamber.

The control unit is adapted to:
receive a load signal indicative of the magnitude of the load applied to the hydraulic actuator, which load is determined to impart a pressure in the actuator chamber;
receive a requested speed signal indicative of a desired relative speed of movement between the first actuator portion and the second actuator portion in a direction that reduces the chamber volume, and
on the basis of the load signal and the requested speed signal, issue a control signal to the flow rate control arrangement indicative of a desired flow rate from the actuator chamber.

The control unit according to the above implies an appropriately controlled movement of the actuator in for instance an operating condition during which the movement of the actuator is the result of an external load applied to a portion of the actuator. Moreover, the above control unit implies that the movement characteristics of the hydraulic actuator, such as the movement speed, may be made dependent on the load applied to the hydraulic actuator without necessarily having to control the fluid flow to an actuator chamber of the hydraulic actuator. Instead, and as indicated above, the movement characteristics of the hydraulic actuator may be made dependent on the load applied to the hydraulic actuator by controlling the flow from an actuator chamber.

Optionally, the control unit is adapted to:
for a requested speed signal indicative of a first desired relative speed and a load signal indicative of a first magnitude of the load, issue a control signal to the flow rate control arrangement indicative of a first desired flow rate from the actuator chamber,
for a requested speed signal indicative of the first desired relative speed and a load signal indicative of a second magnitude of the load, the second magnitude being greater than the first magnitude, issue a control signal to the flow rate control arrangement indicative of a second desired flow rate from the actuator chamber,
the first desired flow rate being greater than or equal to the second desired flow rate.

By virtue of the above, the movement speed of an actuator subjected to a relatively low load, e.g. a relatively low external load, may be higher than or equal to the movement speed of an actuator subjected to a relatively high load, e.g. a relatively high external load. Thus, using an implement of a working machine as an example, the above control unit implies that the implement, when unloaded, may be lowered at speed that is greater than or equal to the speed at which the implement is lowered when loaded, e.g. fully loaded. It should be noted that the above motion characteristics may be obtained even for a “passive” lowering of the implement, i.e. a lowering not necessarily requiring that fluid is fed to an actuator chamber of the actuator but instead uses the weight suspended by the actuator for imparting a movement of the actuator.

Optionally, the control unit is adapted to:
for a requested speed signal indicative of a maximum desired relative speed and a load signal indicative of a first magnitude of the load, issue a control signal to the flow rate control arrangement indicative of a first maximum desired flow rate from the actuator chamber,
for a requested speed signal indicative of the maximum desired relative speed and a load signal indicative of a second magnitude of the load, the second magnitude being greater than the first magnitude, issue a control signal to the flow rate control arrangement indicative of a second maximum desired flow rate from the actuator chamber,
the first maximum desired flow rate being greater than or equal to the second maximum desired flow rate.

The above control unit implies that different maximum movement speeds of the actuator may be the result for different load levels.

Optionally, the hydraulic actuator comprises an additional actuator chamber and the hydraulic actuator is such that the chamber volume of the additional actuator chamber increases when the chamber volume of the actuator chamber decreases. The control unit is adapted to, on the basis of the load signal and the requested speed signal, issue a control signal to the flow rate control arrangement such that at least 50%, preferably at least 80%, of a fluid flow to the additional actuator chamber is fed from the actuator chamber.

As such, the control unit according to the above can employ a “passive” operation of the actuator wherein the movement of the actuator is induced, be it completely or at least partially, by the load applied to the actuator. Such a “passive” operation is generally preferred since the operation generally is energy efficient and the control unit of the present invention provides an appropriately controlled movement of the actuator even in “passive” operations.

A second aspect of the present invention relates to a hydraulic system comprising the hydraulic actuator which in turn comprises the actuator chamber. The actuator comprises the first actuator portion and the second actuator portion wherein the first actuator portion can move relative to the second actuator portion. The hydraulic system further comprises a flow rate control arrangement adapted to control the rate of flow from the actuator chamber. The actuator chamber is in fluid communication with the flow rate control arrangement. The hydraulic system further comprises a control unit according the first aspect of the present invention. As has been indicated above, the control unit is adapted to issue a control signal to the flow rate control arrangement indicative of a desired flow rate from the actuator chamber.

Optionally, the chamber volume is adapted to be reduced upon retraction of the hydraulic actuator, whereby the actuator chamber is a piston side actuator chamber. A hydraulic actuator according to the above, viz with a piston side actuator chamber being adapted to be reduced upon retraction of the hydraulic actuator, may for instance be adapted to control the movement of a boom of a working machine.

Optionally, the flow rate control arrangement comprises a valve arrangement. A valve arrangement is a suitable arrangement for controlling the flow rate from the actuator chamber.

Optionally, the valve arrangement is a pilot pressure actuated valve arrangement, whereby the control unit is adapted to issue the control signal to a pilot valve being in fluid communication with the valve arrangement.

Optionally, the flow rate control arrangement comprises a variable displacement hydraulic motor. By using a variable displacement hydraulic motor for controlling the flow rate from the actuator chamber, it may be possible to recuperate energy from the fluid leaving the actuator chamber.

Optionally, the hydraulic system further comprises a load sensor arrangement adapted to issue the load signal to the control unit.

Optionally, the load sensor arrangement comprises a pressure sensor adapted to measure a pressure in the actuator chamber. The use of a pressure sensor adapted to measure a pressure in the actuator chamber implies a robust and cost efficient means for issuing the load signal indicative of the magnitude of the load applied to the hydraulic actuator.

Optionally, the flow rate control arrangement is in fluid communication with a tank such that the flow rate control arrangement is adapted to control the rate of flow from the actuator chamber to the tank.

Optionally, the hydraulic system further comprises a speed signal input arrangement for issuing the requested speed signal to the control unit.

Optionally, the speed signal input arrangement comprises an actuator operable by an operator.

Optionally, the hydraulic actuator comprises an additional actuator chamber. The hydraulic actuator is such that the chamber volume of the additional actuator chamber increases when the chamber volume of the actuator chamber decreases. The flow rate control arrangement is in fluid communication with the additional actuator chamber.

A third aspect of the present invention relates to a working machine comprising a hydraulic system according to the second aspect of the present invention.

Optionally, the working machine comprises a moveable element. The hydraulic actuator is arranged in relation to the working machine. Optionally, the moveable element is a boom or a bucket.

A fourth aspect of the present invention relates to a method for controlling the movement of a hydraulic system actuator of a hydraulic system. The hydraulic actuator comprises an actuator chamber. The hydraulic actuator comprising a first actuator portion and a second actuator portion wherein the first actuator portion can move relative to the second actuator portion. The actuator chamber is in fluid communication with a flow rate control arrangement adapted to control a rate of flow from the actuator chamber.

The method comprises:
receiving a load signal indicative of the magnitude of the load applied to the hydraulic actuator which load is determined to impart a pressure in the actuator chamber;
receiving a requested speed signal indicative of a desired relative speed of movement between the first actuator portion and the second actuator portion in a direction that reduces the chamber volume, and
on the basis of the load signal and the requested speed signal, issuing a control signal to the flow rate control arrangement indicative of a desired flow rate from the actuator chamber.

Optionally, the method comprises:
for a requested speed signal indicative of a first desired relative speed and a load signal indicative of a first magnitude of the load, issuing a control signal to the flow rate control arrangement indicative of a first desired flow rate from the actuator chamber,
for a requested speed signal indicative of the first desired relative speed and a load signal indicative of a second magnitude of the load, the second magnitude being greater than the first magnitude, issuing a control signal to the flow rate control arrangement indicative of a second desired flow rate from the actuator chamber,
the first desired flow rate being greater than or equal to the second desired flow rate.

Optionally, the method comprises:
for a requested speed signal indicative of a maximum desired relative speed and a load signal indicative of a first magnitude of the load, issuing a control signal to the flow rate control arrangement indicative of a first maximum desired flow rate from the actuator chamber,
for a requested speed signal indicative of the maximum desired relative speed and a load signal indicative of a second magnitude of the load, the second magnitude being greater than the first magnitude, issuing a control signal to the flow rate control arrangement indicative of a second maximum desired flow rate from the actuator chamber,
the first maximum desired flow rate being greater than or equal to the second maximum desired flow rate.

Optionally, the hydraulic actuator comprises an additional actuator chamber. The hydraulic actuator is such that the chamber volume of the additional actuator chamber increases when the chamber volume of the actuator chamber decreases. The method further comprises issuing a control signal to the flow rate control arrangement such that at least 50%, preferably at least 80%, of a fluid flow to the additional actuator chamber is fed from the actuator chamber.

### BRIEF DESCRIPTION OF THE DRAWINGS

With reference to the appended drawings, below follows a more detailed description of embodiments of the invention cited as examples, wherein:

FIG. 1 schematically illustrates a working machine;

FIG. 2 schematically illustrates an embodiment of a hydraulic system according to the present invention;

FIG. 3 is a flow chart presenting an embodiment of the method of the invention, and

FIG. 4 schematically illustrates a graph of the flow rate as a function of a requested speed signal for different load levels.

### DESCRIPTION OF EXAMPLES

The present invention will now be described hereinafter with reference to the accompanying drawings, in which an exemplary embodiment of the invention is shown. The invention may, however, be embodied in many different forms and should not be construed as limited to the embodiment set forth herein; rather, the embodiment is provided for thoroughness and completeness. Like reference character refer to like elements throughout the description.

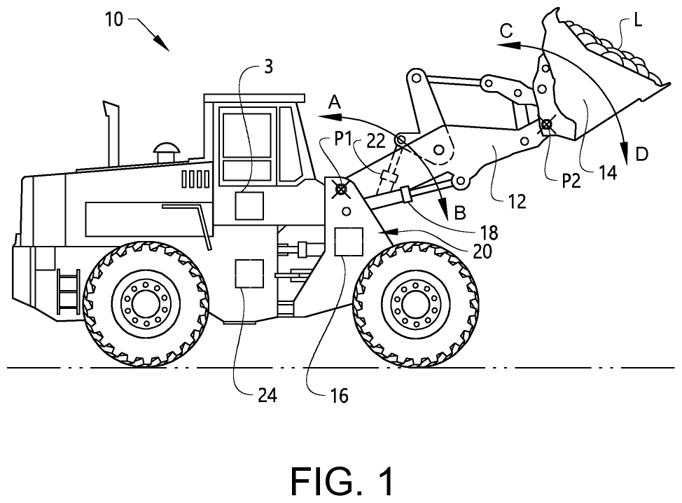

With reference to FIG. 1, there is provided a working machine 10 according to the present invention. The working machine 10 depicted in FIG. 1 is a wheel loader although the present invention may be implemented in other types of working machines or other types of hydraulic systems.

The working machine 10 in FIG. 1 has a boom 12 swingable around a first pivot axis P1 for lifting movement A and lowering movement B of a load L carried in a bucket 14. The bucket 14 is attached to the boom 12 swingable around a second pivot axis P2 for a raising movement C and a dumping movement D. Movements of the boom 12 and of the bucket 14 are performed by a hydraulic system 16. Purely by way of example, the hydraulic system 16 may comprise at least one boom actuator 18 adapted to control the position of the boom 12 relative to a frame 20 of the working machine 10. In a similar vein, and again purely by way of example, the hydraulic system 16 may comprise at least one bucket actuator 22 adapted to control the position of the bucket 14 relative to the boom 12.

The boom 12 may undergo the lowering movement B by retracting the at least one boom actuator 18. Such a retraction may be occasioned by the load L alone or by the load L in combination with a load imparted by a pressure increase in a piston rod side actuator chamber (not shown in FIG. 1) of the at least one boom actuator 18. Purely by way of example, in order to save energy, the lowering movement B may be occasioned by the load L alone, i.e. the lowering movement B may be “passive”.

In a similar vein, the bucket 14 may undergo the dumping movement D by extracting the at least one bucket actuator 22. Such an extraction may be occasioned by the load L alone or by the load L in combination with a load imparted by a pressure increase in a piston side actuator chamber (not shown in FIG. 1) of the at least one bucket actuator 22. Purely by way of example, in order to save energy, the dumping movement D may be occasioned by the load L alone, i.e. the dumping movement D may be “passive”

In FIG. 1, each one of the boom actuator 18 and the bucket actuator 22 is implemented as a hydraulic cylinder. The hydraulic system 16 may be operated by a control unit 24 as will be discussed further hereinbelow.

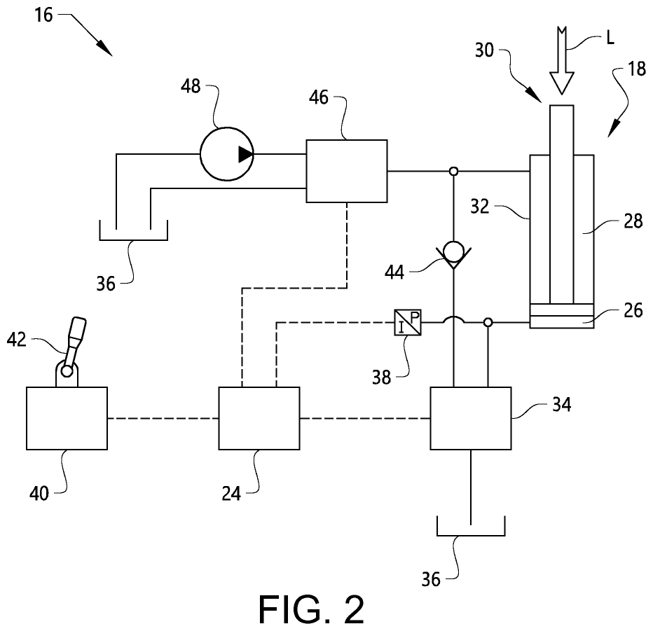

FIG. 2 illustrates an embodiment of a hydraulic system 16. The FIG. 2 hydraulic system 16 comprises a hydraulic actuator 18 which in turn comprises an actuator chamber 26. In the FIG. 2 embodiment, the chamber volume of the actuator chamber 26 is adapted to be reduced upon retraction of the hydraulic actuator 18, whereby the actuator chamber 26 is a piston side actuator chamber. However, it is also envisaged that embodiments of the hydraulic system 16 may comprise hydraulic actuator with an actuator chamber 26 the chamber volume of which is adapted to be reduced upon extraction of the hydraulic actuator whereby the actuator chamber could for instance be a piston rod side actuator chamber (such an implementation is not illustrated in FIG. 2).

Furthermore, in the FIG. 2 embodiment, the hydraulic actuator 18 is exemplified as the boom actuator 18 illustrated in FIG. 1. However, it is of course also envisaged that the hydraulic actuator 18 may be used in another type of working machine or in another system.

Further, as indicated in FIG. 2, the actuator 18 comprises the first actuator portion 30 and the second actuator portion 32 wherein the first actuator portion 30 can move relative to the second actuator portion 32. For instance, and as illustrated in FIG. 2, the first actuator portion 30 may comprise a rod and piston of the actuator 18 and the second actuator portion 32 may comprise a housing of the actuator.

The hydraulic system 16 further comprises a flow rate control arrangement 34 adapted to control the rate of flow from the actuator chamber 26. The actuator chamber 26 is in fluid communication with the flow rate control arrangement 34. Purely by way of example, and as indicated in the FIG. 2 embodiment, the flow rate control arrangement may be in fluid communication with a tank 36 such that the flow rate control arrangement 34 is adapted to control the rate of flow from the actuator chamber 26 to the tank 36. As an alternative, the flow rate control arrangement 34 may be adapted to control the rate of flow from the actuator chamber 26 to the inlet of a pump, such as the pump 48 illustrated in FIG. 2. The hydraulic system 16 further comprises a control unit 24 adapted to control the flow rate control arrangement 34, e.g. by issuing a signal to the flow rate control arrangement 34 as indicated in FIG. 2.

The flow rate control arrangement 34 may be implemented in a plurality of different ways. As a first non-limiting example, the flow rate control arrangement 34 may comprise a valve arrangement. Purely by way of example, such a valve arrangement may comprise an aperture, the size of which may be variable to thereby control the rate of flow from the actuator chamber 26 and e.g. to the tank 36 illustrated in the FIG. 2 embodiment. Such a valve arrangement may for instance comprise, or be constituted by, a pilot pressure actuated valve arrangement, whereby the control unit is adapted to issue the control signal to a pilot valve being in fluid communication with the valve arrangement. As such, box 34 in FIG. 2 may in such an embodiment be deemed to illustrate a valve arrangement.

Instead of, or in addition to, the above discussed valve arrangement, the flow rate control arrangement 34 may comprise a variable displacement hydraulic motor. In such an implementation, the control unit 24 may be adapted to control the flow rate control arrangement 34 by issuing a signal indicative of a desired displacement of such a hydraulic motor. As such, box 34 in FIG. 2 may in such an embodiment be deemed to illustrate a variable displacement hydraulic motor.

Moreover, the hydraulic system 16 preferably further comprises a load sensor arrangement adapted to issue a load signal to the control unit 24. In the FIG. 2 embodiment, the load sensor arrangement comprises a pressure sensor 38 adapted to measure a pressure in the actuator chamber 26. However, it is also envisaged that the other embodiments of the hydraulic system 16 may comprise other load sensor arrangement implementations, e.g. implementations comprising a load cell (not shown) or the like.

Further, the hydraulic system 16 preferably comprises a speed signal input arrangement 40 for issuing a requested speed signal, i.e. a signal indicative of a desired relative speed of movement between the first actuator portion 30 and the second actuator portion 32, to the control unit 24. Purely by way of example, the speed signal input arrangement 40 may be adapted to automatically generate the above signal, e.g. in the event that the hydraulic system forms part of a driverless working machine (not shown). However, in the FIG. 2 embodiment, the speed signal input arrangement 40 comprises an actuator 42 operable by an operator. In the implementation illustrated in FIG. 2, the actuator 42 is a lever but it is also conceivable that the actuator 42 may be implemented as a knob, a touch screen or any other device that an operator can actuate in order to indicate a desired speed.

Moreover, the FIG. 2 hydraulic actuator 18 comprises an additional actuator chamber 28. The hydraulic actuator 18 is such that the chamber volume of the additional actuator chamber 28 increases when the chamber volume of the actuator chamber 26 decreases. In the FIG. 2 implementation of the hydraulic actuator 18, the additional actuator chamber 28 is a rod side actuator chamber. Further, as illustrated in FIG. 2, the additional actuator chamber 28 may be in fluid communication with the flow rate control arrangement 34. Purely by way of example, and as indicated in FIG. 2, the additional actuator chamber 28 may be in fluid communication with the flow rate control arrangement 34 via a one-way valve allowing fluid to flow through it from the flow rate control arrangement 34 to the additional actuator chamber 28 but preventing fluid to flow through it from the additional actuator chamber 28 to the flow rate control arrangement 34. Moreover, the flow rate control arrangement 34 may be such that it only allows fluid to flow from the actuator chamber 26 to the tank 36 when the pressure in the actuator chamber 26 exceeds a predetermined threshold pressure. As a non-limiting example, the predetermined threshold pressure may be within the range of 2-10 bar, preferable approximately 5 bar. To this end, though purely by way of example, the flow rate control arrangement 34 may comprise a pressure limiting valve (not shown).

FIG. 2 further illustrates that the hydraulic system 16 may comprise an additional flow rate control arrangement 46 which is in fluid communication with the additional actuator chamber 28. As may be gleaned from FIG. 2, though illustrated purely by way of example, the additional flow rate control arrangement 46 may comprise or be constituted by a valve. It should be noted that in embodiments of the hydraulic system 16 in which the flow rate control arrangement 34 comprises or is constituted by a valve and in which the additional flow rate control arrangement 46 comprises or is constituted by a valve, such a flow rate control arrangement 34 valve and the additional flow rate control arrangement 46 valve may be combined to a valve assembly.

Moreover, though purely by way of example, hydraulic system 16 may comprise a pump 48. Purely by way of example, the pump 48 may form part of a load sensing system.

As has been intimated above, the control unit 24 is adapted to receive a signal indicative of the indicative of the magnitude of the load L applied to the hydraulic actuator 18 as well as a signal indicative of a desired relative speed of movement between the first actuator portion 30 and the second actuator portion 32. Moreover, the control unit 24 is adapted to issue a control signal to the flow rate control arrangement 34.

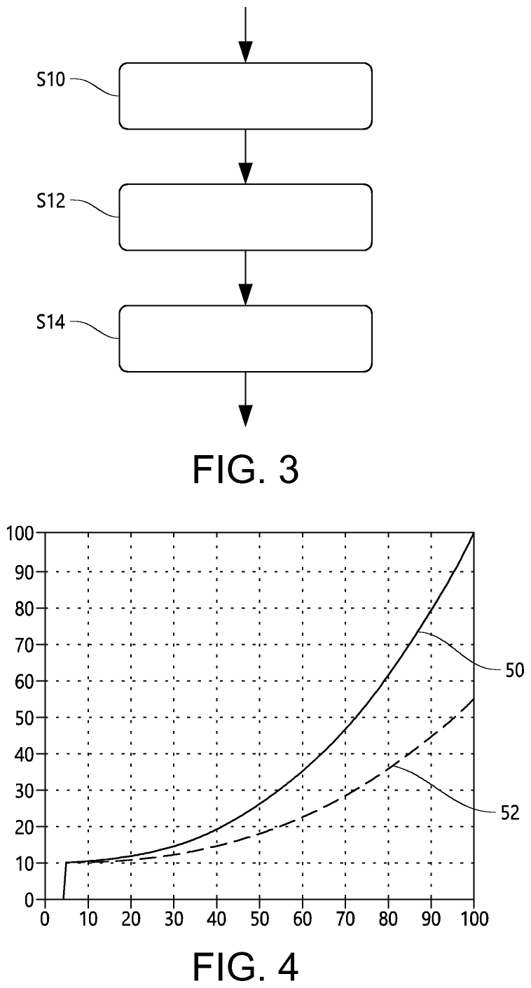

An example of how the above signals are received and issued is presented hereinbelow with reference to the flow chart illustrated in FIG. 3. The FIG. 3 flow chart illustrates a method that may be carried out by a control unit 24, such as the implementation of the control unit 24 discussed above. However, it is also envisaged that the below discussed method may be carried out using other means (not shown).

As such, with reference to FIG. 3, a method according to the present invention may comprise the following:
S10: receiving a load signal indicative of the magnitude of the load applied to the hydraulic actuator 18, which load is determined to impart a pressure in the actuator chamber 26;
S12: receiving a requested speed signal indicative of a desired relative speed of movement between the first actuator portion and the second actuator portion 32 in a direction that reduces the chamber volume, and
S14 on the basis of the load signal and the requested speed signal, issuing a control signal to the flow rate control arrangement 24 indicative of a desired flow rate from the actuator chamber 26.

It should be noted that the above method steps need not be performed in the above presented order. For instance, it is envisaged that alternative embodiments of the method of the invention may perform step S10 before step S12. It is also envisaged that embodiments of the method may carry out steps S10 and S12 with an, at least partially, temporal overlap. As has been intimated above, the control unit 24 may be adapted to carry out the above steps, for instance in one or more of the above discussed orders.

As such, for the sake of completeness, the control unit 24 is adapted to:
receive a load signal indicative of the magnitude of the load applied to the hydraulic actuator 18, which load is determined to impart a pressure in the actuator chamber 26;
receive a requested speed signal indicative of a desired relative speed of movement between the first actuator portion 30 and the second actuator portion 32 in a direction that reduces the chamber volume, and
on the basis of the load signal and the requested speed signal, issue a control signal to the flow rate control arrangement 24 indicative of a desired flow rate from the actuator chamber 26.

With reference to FIG. 4, though purely by way of example, the control unit 34 of the present invention may be adapted to and/or the method of the present invention may comprise the following:
for a requested speed signal indicative of a first desired relative speed and a load signal indicative of a first magnitude of the load, issue a control signal to the flow rate control arrangement 34 indicative of a first desired flow rate from the actuator chamber,
for a requested speed signal indicative of the first desired relative speed and a load signal indicative of a second magnitude of the load, the second magnitude being greater than the first magnitude, issue a control signal to the flow rate control arrangement indicative of a second desired flow rate from the actuator chamber,
the first desired flow rate being greater than or equal to the second desired flow rate.

The above capability is clarified with reference to FIG. 4 which is a graph, the abscissa of which represents a normalized requested speed signal, i.e. from 0-100% of a maximum requested speed signal, and the ordinate of which represents a value indicative of a flow rate from the actuator chamber. As such, in implementations of the flow rate control arrangement 34 comprising a valve arrangement, the ordinate represents a normalized aperture size, from 0-100% of a maximum aperture size, whereas in implementations of the flow rate control arrangement 34 comprising a hydraulic motor, the ordinate represents a normalized displacement, from 0-100% of a maximum displacement, of the hydraulic motor. Further, as has been intimated above, the requested speed signal may be generated automatically and/or by using a manually operated input device.

Moreover, FIG. 4 illustrates the flow rate as a function of a requested speed signal for different load levels. In FIG. 4, two different load levels are illustrated: minimum load level 50 and a maximum load level 52. As may be gleaned from FIG. 4, for any normalized requested speed signal exceeding approximately 5%, the flow rate for the minimum load level 50 is greater that the flow rate for the maximum load level 52. Consequently, using a work machine boom actuator, for instance the FIG. 1 boom actuator 18, as an example, the FIG. 4 graphs illustrate that a boom that is lowered by means of gravity will be lowered more quickly when an implement connected to the boom, such as the FIG. 1 bucket, carries no load than when the implement carries a full load. Needless to say, the control unit may be able to use flow rates as a function of a requested speed signal for a plurality of different intermediate load levels, i.e. load levels between minimum load level 50 and the maximum load level 52.

Moreover, again with reference to FIG. 4, the control unit 34 of the present invention may be adapted to and/or the method of the present invention may comprise the following:
for a requested speed signal indicative of a maximum desired relative speed and a load signal indicative of a first magnitude of the load, issue a control signal to the flow rate control arrangement 34 indicative of a first maximum desired flow rate from the actuator chamber,
for a requested speed signal indicative of the maximum desired relative speed and a load signal indicative of a second magnitude of the load, the second magnitude being greater than the first magnitude, issue a control signal to the flow rate control arrangement 34 indicative of a second maximum desired flow rate from the actuator chamber,
the first maximum desired flow rate being greater than or equal to the second maximum desired flow rate.

As such, when a maximum desired relative speed is received by e.g. the control unit 24, the desired flow rate in a condition with a low load may be greater than the desired flow rate in a condition with a higher load.

Furthermore, embodiments of the hydraulic system 16 are contemplated which comprises a hydraulic actuator 18 which in turn comprises an additional actuator chamber 28 wherein the hydraulic actuator 18 is such that the chamber volume of the additional actuator chamber 28 increases when the chamber volume of said actuator chamber 26 decreases. An example of such an embodiment is presented hereinabove with reference to FIG. 2.

For a hydraulic system 16 embodiment as recited above, the control unit 24 may be adapted to, on the basis of the above-mention load signal and the requested speed signal viz a load signal indicating that the load L is determined to impart a pressure in the actuator chamber 26 and a requested speed signal indicative of a direction that reduces the chamber volume of the actuator chamber 26—issue a control signal to the flow rate control arrangement 34 such that at least 50%, preferably at least 80%, of a fluid flow to the additional actuator chamber 28 is fed from the actuator chamber 26.

As such, again with reference to the FIG. 2 embodiment, the control unit 24 may be adapted to issue a signal to the flow rate control arrangement 34 so as to connect the additional actuator chamber 28 to the actuator chamber 26 on the basis of the above-mention load signal and the requested speed signal. As such, the control unit 24 may employ a “passive” retraction of the FIG. 2 actuator 18 in which fluid is fed from the actuator chamber 26, the volume of which is reduced, to the additional actuator chamber 28 when the load L retracts the actuator 18.

Instead of, or in addition to, the above discussed fluid communication between the actuator chamber 26 and the additional actuator chamber 28, it is also contemplated that the control unit 24 may be adapted to, on the basis of the above-mention load signal and the requested speed signal, issue a control signal to the additional flow rate control arrangement 46 such that at least a portion of the fluid flow to the additional actuator chamber 28 is fed from a tank 36 by suction induced by the volume increase of the additional actuator chamber 28. Furthermore, it is of course also conceivable that the additional flow rate control arrangement 46 discussed hereinabove with reference to FIG. 2 may be set such that a small portion of fluid is supplied to the additional actuator chamber 28 by the FIG. 2 pump 48.

It is to be understood that the present invention is not limited to the embodiments described above and illustrated in the drawings; rather, the skilled person will recognize that many changes and modifications may be made within the scope of the appended claims.

1. A control unit for a hydraulic system, said hydraulic system comprising a hydraulic actuator which in turn comprises an actuator chamber, said hydraulic actuator comprising a first actuator portion and a second actuator portion wherein said first actuator portion can move relative to said second actuator portion, said actuator chamber being in fluid communication with a flow rate control arrangement adapted to control a rate of flow from said actuator chamber, wherein said control unit is adapted to:
receive a load signal indicative of the magnitude of said load applied to said hydraulic actuator, which load is determined to impart a pressure in said actuator chamber;
receive a requested speed signal indicative of a desired relative speed of movement between said first actuator portion and said second actuator portion in a direction that reduces a chamber volume of the actuator chamber; and
on the basis of said load signal and said requested speed signal, issue a control signal to said flow rate control arrangement indicative of a desired flow rate from said actuator chamber.

2. The control unit according to claim 1, wherein said control unit is adapted to:
for a requested speed signal indicative of a first desired relative speed and a load signal indicative of a first magnitude of said load, issue a control signal to said flow rate control arrangement indicative of a first desired flow rate from said actuator chamber.
for a requested speed signal indicative of said first desired relative speed and a load signal indicative of a second magnitude of said load, said second magnitude being greater than said first magnitude, issue a control signal to said flow rate control arrangement indicative of a second desired flow rate from said actuator chamber,
said first desired flow rate being greater than or equal to said second desired flow rate.

3. The control unit according to claim 1, wherein said control unit is adapted to:
for a requested speed signal indicative of a maximum desired relative speed and a load signal indicative of a first magnitude of said load, issue a control signal to said flow rate control arrangement indicative of a first maximum desired flow rate from said actuator chamber,
for a requested speed signal indicative of said maximum desired relative speed and a load signal indicative of a second magnitude of said load, said second magnitude being greater than said first magnitude, issue a control signal to said flow rate control arrangement indicative of a second maximum desired flow rate from said actuator chamber,
said first maximum desired flow rate being greater than or equal to said second maximum desired flow rate.

4. The control unit according to claim 1, wherein said hydraulic actuator comprises an additional actuator chamber, said hydraulic actuator being such that the chamber volume of said additional actuator chamber increases when the chamber volume of said actuator chamber decreases, said control unit being adapted to, on the basis of said load signal and said requested speed signal, issue a control signal to said flow rate control arrangement such that at least 50%, preferably at least 80%, of a fluid flow to said additional actuator chamber is fed from said actuator chamber.

5. A hydraulic system comprising said hydraulic actuator which in turn comprises said actuator chamber, said actuator comprising said first actuator portion and said second actuator portion wherein said first actuator portion can move relative to said second actuator portion, said hydraulic system further comprising a flow rate control arrangement adapted to control said rate of flow from said actuator chamber, said actuator chamber being in fluid communication with said flow rate control arrangement, said hydraulic system further comprising a control unit according to claim 1.

6. The hydraulic system according to claim 5, wherein said chamber volume is adapted to be reduced upon retraction of said hydraulic actuator, whereby said actuator chamber is a piston side actuator chamber.

7. The hydraulic system according to claim 5, wherein said flow rate control arrangement comprises a valve arrangement.

8. The hydraulic system according to claim 7, wherein said valve arrangement is a pilot pressure actuated valve arrangement, whereby said control unit is adapted to issue said control signal to a pilot valve being in fluid communication with said valve arrangement.

9. The hydraulic system according to claim 5, wherein said flow rate control arrangement comprises a variable displacement hydraulic motor.

10. The hydraulic system according to claim 5, further comprising a load sensor arrangement adapted to issue said load signal to said control unit.

11. The hydraulic system according to claim 10, wherein said load sensor arrangement comprises a pressure sensor adapted to measure a pressure in said actuator chamber.

12. The hydraulic system according to claim 5, wherein said flow rate control arrangement is in fluid communication with a tank such that said flow rate control arrangement is adapted to control said rate of flow from said actuator chamber to said tank.

13. The hydraulic system according to claim 5, wherein said hydraulic system further comprises a speed signal input arrangement for issuing said requested speed signal to said control unit.

14. The hydraulic system according to claim 13, wherein said speed signal input arrangement comprises an actuator operable by an operator.

15. The hydraulic system according to claim 5, wherein said hydraulic actuator comprises an additional actuator chamber, said hydraulic actuator being such that the chamber volume of said additional actuator chamber increases when the chamber volume of said actuator chamber decreases, the flow rate control arrangement being in fluid communication with said additional actuator chamber.

16. A working machine comprising a hydraulic system according to claim 5.

17. The working machine according to claim 16, wherein said working machine comprises a moveable element, said hydraulic actuator being arranged in relation to said working machine, preferably said moveable element being a boom or a bucket.

18. A method for controlling movement of a hydraulic system actuator of a hydraulic system, said hydraulic actuator comprising an actuator chamber, said hydraulic actuator comprising a first actuator portion and a second actuator portion wherein said first actuator portion can move relative to said second actuator portion, said actuator chamber being in fluid communication with a flow rate control arrangement adapted to control a rate of flow from said actuator chamber, said method comprising:
receiving a load signal indicative of the magnitude of said load applied to said hydraulic actuator, which load is determined to impart a pressure in said actuator chamber;
receiving a requested speed signal indicative of a desired relative speed of movement between said first actuator portion and said second actuator portion in a direction that reduces a chamber volume of the actuator chamber; and
on the basis of said load signal and said requested speed signal, issuing a control signal to said flow rate control arrangement indicative of a desired flow rate from said actuator chamber.

19. The method according to claim 18, wherein said method comprises:
for a requested speed signal indicative of a first desired relative speed and a load signal indicative of a first magnitude of said load, issuing a control signal to said flow rate control arrangement indicative of a first desired flow rate from said actuator chamber,
for a requested speed signal indicative of said first desired relative speed and a load signal indicative of a second magnitude of said load, said second magnitude being greater than said first magnitude, issuing a control signal to said flow rate control arrangement indicative of a second desired flow rate from said actuator chamber,
said first desired flow rate being greater than or equal to said second desired flow rate.

20. The method according to claim 18, wherein said method comprises:
for a requested speed signal indicative of a maximum desired relative speed and a load signal indicative of a first magnitude of said load, issuing a control signal to said flow rate control arrangement indicative of a first maximum desired flow rate from said actuator chamber,
for a requested speed signal indicative of said maximum desired relative speed and a load signal indicative of a second magnitude of said load, said second magnitude being greater than said first magnitude, issuing a control signal to said flow rate control arrangement indicative of a second maximum desired flow rate from said actuator chamber,
said first maximum desired flow rate being greater than or equal to said second maximum desired flow rate.

21. (canceled)
